(19) United States
(12) Patent Application Publication
(10) Pub. No.: US 2015/0171412 A1
(43) Pub. Date: Jun. 18, 2015

(54) SECONDARY BATTERY COLLECTOR TERMINAL AND SECONDARY BATTERY

(71) Applicants: Mizuho Matsumoto, Toyota-shi (JP); Masashi Kato, Konan-shi (JP)

(72) Inventors: Mizuho Matsumoto, Toyota-shi (JP); Masashi Kato, Konan-shi (JP)

(73) Assignee: TOYOTA JIDOSHA KABUSHIKI KAISHA, Toyota-shi, Aichi-ken (JP)

(21) Appl. No.: 14/411,620

(22) PCT Filed: Sep. 6, 2013
(86) PCT No.: PCT/IB2013/001910

§ 371 Date: Dec. 29, 2014

(30) Foreign Application Priority Data
Sep. 7, 2012 (JP) 2012-197063

(51) Int. Cl. H01M 2/34; H01M 10/42

(52) U.S. Cl. CPC H01M 2/345; H01M 10/4235; H01M 2200/20

(57) ABSTRACT

A collector terminal of a secondary battery includes a base portion, a terminal leg portion, and a connecting portion that connects to a current interrupting mechanism. The base portion is a plate member facing the current interrupting mechanism, and including a cutout portion and a connecting portion that connects to the current interrupting mechanism. The terminal leg portion protrudes from the base portion, and extends to a side of the base portion opposite the current interrupting mechanism side. The cutout portion is provided between the connecting member and the terminal leg portion.

### BACKGROUND OF THE INVENTION

1. Field of the Invention

The invention relates to a collector terminal of a secondary′ battery and a secondary battery provided with this collector terminal.

2. Description of Related Art

Secondary batteries are becoming increasingly important as power supplies mounted in vehicles that use electricity as a driving source, or power supplies used in electrical products such as personal computers and mobile terminals and the like. In particular, lithium-ion secondary batteries that are lightweight and able to obtain a high energy density are preferable as high output power supplies mounted in vehicles.

For example, a lithium-ion battery includes an electrode body, a battery case within which the electrode body is housed, a positive terminal and a negative terminal that are electrically connected to the electrode body, and a sealing body that fits to an open portion of the battery case. The electrode body is formed by a sheet-like positive electrode and a sheet-like negative electrode stacked together via a sheet-like separator. The electrode body is rolled and housed in the battery case. The positive terminal and the negative terminal are attached to the sealing body. The lithium-ion secondary battery is formed by fitting the sealing body to the open portion of the battery case.

The positive terminal has an external positive terminal and an internal positive terminal. Similarly, the negative terminal has an external negative terminal and an internal negative terminal. The external positive terminal and the external negative terminal are both arranged on the outside of the sealing body, and the internal positive terminal and the internal negative terminal are both arranged on the battery case side of the sealing body. The internal positive terminal and the internal negative terminal serve as collector terminals that collect power from the electrode body. These collector terminals are held to the sealing body via an insulating member. The insulating member prevents current from leaking out of the collector terminal and the like unnecessarily. The insulating member is made of resin material.

A current interrupting mechanism is provided between the collector terminal, and the external positive terminal and the external negative terminal. The current interrupting mechanism is made of metal foil. An edge portion of the current interrupting mechanism is electrically connected to the external positive terminal and the external negative terminal. The current interrupting mechanism is electrically connected near the center portion thereof to the collector terminal. If pressure inside a case formed by the battery case and the sealing body rises due to defective operation of the secondary battery or the like, the current interrupting mechanism will be pushed upward (to the sealing body side) by the pressure, and the connection between the current interrupting mechanism and the collector terminal will break. As a result, the collector terminal will be insulated from the external positive terminal and the external negative terminal. In other words, the current interrupting mechanism is a diaphragm that is made of metal foil.

In some cases, external force is applied to the collector terminal. More specifically, a tensile load toward the inside of the battery case or external force from vibration or the like may be applied to the collector terminal. The collector terminal is held to the sealing body via the insulating member, and the insulating member is made of resin material. Therefore, if the external force is applied to the collector terminal, stress may be transmitted to a connecting portion that connects the collector terminal to the current interrupting mechanism. Then the stress that is transmitted to the connecting portion that connects the collector terminal to the current interrupting mechanism may result in a load being applied to the current interrupting mechanism, an increase in electrical resistance, a decrease in power storing function, and defective operation of the secondary battery.

Japanese Patent No. 4911214 describes a secondary battery characterized by a mounting structure of an external positive terminal and an external negative terminal. More specifically, the mounting structure of the external positive terminal and the external negative terminal described in Japanese Patent No. 4911214 includes a rivet terminal, a terminal connecting rod that connects the rivet terminal to the sealing body, a bolt that bolts the terminal connecting rod to the sealing body, and a terminal retainer plate provided between the rivet terminal and the bolt. The rivet terminal is crimped to the terminal connecting rod. Also, the terminal retainer plate is a long thin resin plate that is connected to the sealing body via the terminal connecting rod. Also, force is applied to the terminal connecting rod when the terminal connecting rod is bolted to the sealing body by the bolt. As a result, the connecting portion (i.e., the crimped portion) that connects the terminal connecting rod to the rivet terminal is inhibited from becoming loose and separating from the sealing body by the terminal retainer plate. In this way, with the secondary battery described in Japanese Patent No. 4911214, force is prevented from being applied to the rivet terminal, so the rivet terminal is prevented from being damaged, when connecting the external positive terminal and the external negative terminal to the sealing body.

However, Japanese Patent No. 4911214 makes no mention of stress being transmitted to the connecting portion that is connected to the current interrupting mechanism in the secondary battery. Therefore, with the mounting structure of the external positive terminal and the external negative terminal described in Japanese Patent No. 4911214, if external force is applied to the collector terminal, it may be difficult to prevent stress from being transmitted to the connecting portion that connects the collector terminal to the current interrupting mechanism.

### SUMMARY OF THE INVENTION

A first aspect of the invention relates to a collector terminal of a secondary battery. This collector terminal includes a base portion that is a plate member facing a current interrupting mechanism, and including a cutout portion and a connecting portion that connects to the current interrupting mechanism; and a terminal leg portion protruding from the base portion, and extending to a side of the base portion opposite the current interrupting mechanism side. The cutout portion is provided between the connecting member and the terminal leg portion.

With this structure, even if external force is applied to the terminal leg portions, the transmission of stress to the connecting portion that connects the collector terminal to the current interrupting mechanism is able to be inhibited by the cutout portions.

In the collector terminal, the base portion includes a plurality of the cutout portions, a plurality of the terminal leg portions protrude from the base portion, and the cutout portions may be provided between the terminal leg portions and the connecting portion, in positions symmetrical with respect to a center point of the connecting portion.

According to this structure, when a tensile load is applied to the terminal leg portions in a direction toward the inside of the battery case (i.e., the side opposite the current interrupting mechanism side), the transmission of stress to the connecting portion that connects the collector terminal to the current, interrupting mechanism can be even more reliably inhibited by the cutout portions.

In the collector terminal described above, each of the cutout portions may be an arc-shaped slit, and be partially encircling the connecting portion.

This structure makes it possible to more reliably inhibit the transmission of stress to the connecting portion that connects to the current interrupting mechanism by the cutout portions. Also, a current conduction path in the base portion of the collector terminal can be shortened, so there is less electrical resistance, compared with when the cutout portions are linear-shaped slits.

In the collector terminal described above may further includes a protruding portion provided substantially parallel to a straight line that connects the connecting portion to the terminal leg portions, and is provided on the base portion, in a position to an outside of the connecting portion.

According to this structure, the strength of the base portion is increased by the protruding portion, so the base portion is able to be inhibited from bending when a textile load is applied to the terminal leg portions. Therefore, stress that would be transmitted to the connecting portion that connects the collector terminal to the current interrupting mechanism is able to be inhibited from being generated.

In the collector terminal described above, the base portion may be a plate member with an N-angular shape (where N is an integer of 3 or greater), and a retaining portion that retains the collector terminal may be provided on an angular portion of the base portion.

According to this structure, the tensile load, applied to the terminal leg portions is able to be evenly supported by the retaining portions, so deformation of the base portion is able to be inhibited. Thus, stress that would be transmitted to the connecting portion that connects the collector terminal to the current interrupting mechanism is able to be inhibited from being generated.

In the collector terminal described above, the base portion may be a rectangular-shaped plate member. Each of the terminal leg portions may be a plate member extending from one end portion on two opposing sides of the base portion. Each of the cutout portions may be a linear-shaped slit, being provided parallel to a side on which the terminal leg portions are not provided, and extending from a position that is closer to the connecting portion than the terminal leg portions, on a side of the base portion on which the terminal leg portions are provided.

According to this structure, even if external force that acts in a short direction of the terminal leg portions is applied to the terminal leg portions, stress is able to be inhibited from being transmitted to the connecting portion that connects the collector terminal to the current interrupting mechanism.

In the collector terminal described above may further includes a protruding portion provided substantially parallel to a side on which the terminal leg portions, and is provided on the base portion, in a position that is closer to the terminal leg portion than the connecting portion.

According to this structure, the strength of the base portion is increased by the protruding portion, so the base portion is able to be inhibited from bending even when external force (such as vibration) that acts in the short direction of the terminal leg portions is applied. Therefore, stress that would be transmitted to the connecting portion that connects the collector terminal to the current interrupting mechanism is able to be inhibited from being generated.

A second aspect of the invention relates to a secondary battery provided with the collector terminal according to the first aspect.

Accordingly, even if external force is applied to the terminal leg portions of the collector terminal, stress is able to be inhibited from being transmitted to the connecting portion that connects the collector terminal to the current interrupting mechanism. Also, it is also possible to inhibit an increase in electrical resistance, a decrease in power storing function, and defective operation of the secondary battery.

The invention thus makes it possible to inhibit stress from being transmitted to the connecting portion that connects the collector terminal to the current interrupting mechanism when external force is applied to the collector terminal.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a side view of a secondary battery according to a first example embodiment of the invention;

FIGS. 2A and 2B are perspective views showing frame formats of a collector terminal according to the first example embodiment of the invention;

FIG. 3 is a plan view, of the collector terminal according to the first example embodiment of the invention, viewed from the inside of a battery case;

FIG. 4 is a perspective view of a connection between the collector terminal and a sealing body according to the first example embodiment of the invention;

FIG. 5 is a sectional view of a connecting portion that connects the collector terminal to the sealing body according to the first example embodiment of the invention;

FIG. 6 is a plan view of the collector terminal according to Example 1 of the invention, viewed from the inside of the battery case;

FIG. 7 is a plan view of a collector terminal according to Example 2 of the invention, viewed from the inside of the battery case;

FIGS. 8A and 8B are plan views of a collector terminal according to Example 3 of the invention, viewed from the inside of the battery case;

FIG. 9 is a plan view of a collector terminal according to Comparative Example 1, viewed from the inside of the battery case; and

FIG. 10 is a perspective view of a connection between a collector terminal and a sealing body according to a second example embodiment of the invention.

### DETAILED DESCRIPTION OF EMBODIMENTS

Hereinafter, example embodiments of the invention will be described with reference to the accompanying drawings. The example embodiments of the invention are examples in which the invention is applied to a collector terminal and a sealed secondary battery having a pressure-type current interrupting mechanism.

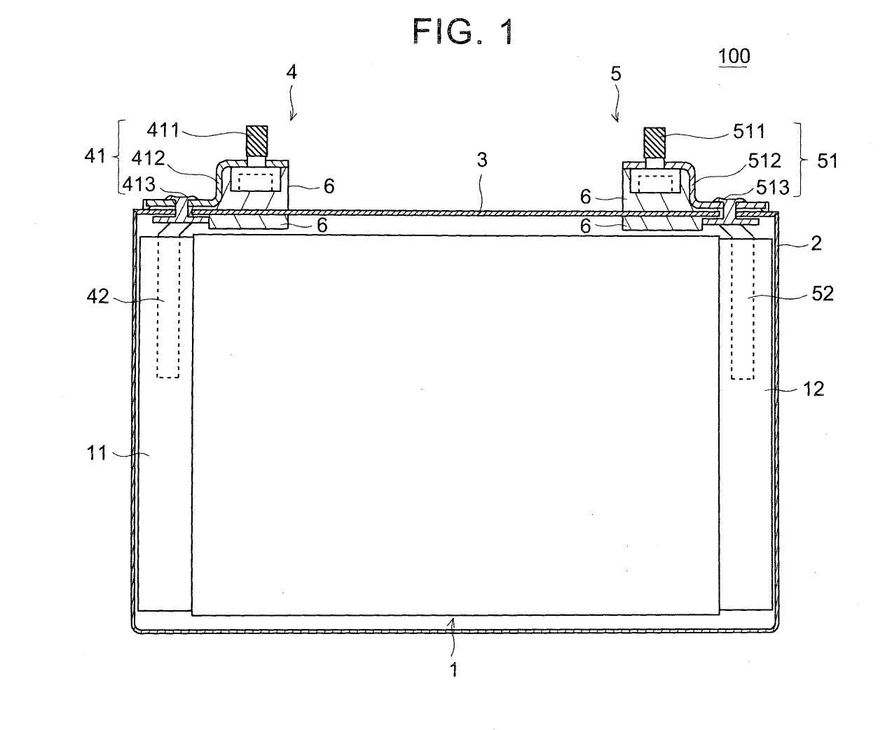

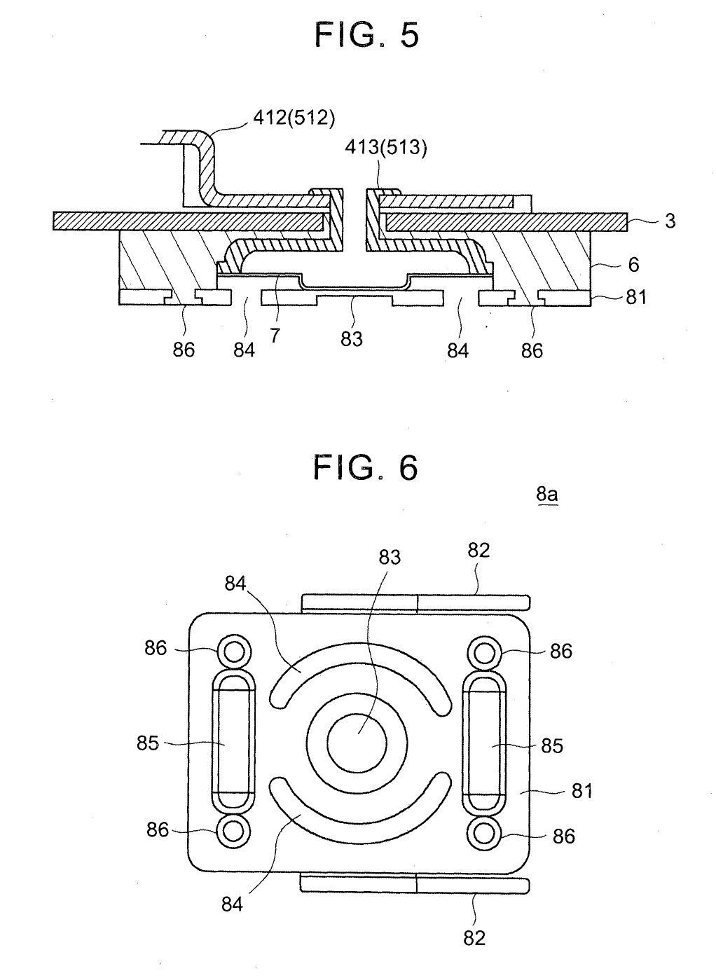

A first example embodiment will be described with reference to FIGS. 1 to 6. FIG. 1 is a side view of a secondary battery 100 according to the first example embodiment of the invention. The secondary battery 100 is a sealed lithium-ion secondary battery. The secondary battery 100 includes an electrode body 1, a battery case 2, a sealing body 3, a positive terminal 4, a negative terminal 5, an insulating member 6, and a current interrupting mechanism 7 (see FIG. 5) and the like, as shown in FIG. 1.

The electrode body 1 is formed by a positive electrode sheet 11 and a negative electrode sheet 12 stacked together via a separator (not shown). The electrode body 1 is rolled in a flat shape and housed in the battery case 2. The rolled electrode body 1 will hereinafter be referred to as a rolled body 1. As shown in FIG. 1, in the rolled body 1, an end portion of the positive electrode sheet 11 and an end portion of the negative electrode sheet 12 are exposed. Then the positive terminal 4 is electrically connected to the end portion of the positive electrode sheet 11. Similarly, the negative terminal 5 is electrically connected to the end portion of the negative electrode sheet 12.

The battery case 2 is a flat box-shaped member. The rolled body 1 and a non-aqueous electrolyte are housed inside the battery case 2. An upper side of the battery case 2 is open. The sealing body 3 is fitted to the open portion of the battery case 2. That is, the battery case 2 and the sealing body 3 together form a case of the secondary battery 100. The battery case 2 and the sealing body 3 are made of metal.

The insulating member 6 is provided between the positive terminal 4 and the sealing body 3, as well as between the negative terminal 5 and the sealing body 3. The insulating member 6 is made mainly of resin material. The insulating member 6 prevents current from flowing out of the positive terminal 4 and the negative terminal 5 unnecessarily.

The positive terminal 4 includes an external positive terminal 41 and an internal positive terminal 42 and the like. The external positive terminal 41 includes a bolt 411, a connecting member 412, and a crimping member 413 and the like. The connecting member 412 includes a threaded hole portion that the bolt 411 screws into. The bolt 411 is connected to the connecting member 412 by screwing into the threaded hole portion. The connecting member 412, the sealing body 3, and the insulating member 6 each have a crimping hole portion. The insulating member 6, the sealing body 3, and the connecting member 412 are crimped by the crimping member 413 at the crimping hole portion of each member. As a result, the insulating member 6, the sealing body 3, and the connecting member 412 are all connected together. Thus, the external positive terminal 41 is connected to the sealing body 3 via the insulating member 6. The internal positive terminal 42 is arranged on the battery case 2 side of the sealing body 3. The internal positive terminal 42 is electrically connected to the exposed end portion of the positive electrode sheet 11 of the rolled body 1. The internal positive terminal 42 serves as a collector terminal that collects power from the electrode body 1 (the rolled body 1).

The negative terminal 5 includes an external negative terminal 51 and an internal negative terminal 52 and the like. The external negative terminal 51 includes a bolt 511, a connecting member 512, and a crimping member 513 and the like. As shown in FIG. 1, the structure of the negative terminal 5 is bilaterally symmetrical to the structure of the positive terminal 4, so a description thereof will be omitted. The internal negative terminal 52 is electrically connected to the exposed end portion of the negative electrode sheet 12 of the rolled body 1. The internal negative terminal 52 serves as a collector terminal that collects power from the electrode body 1 (the rolled body 1).

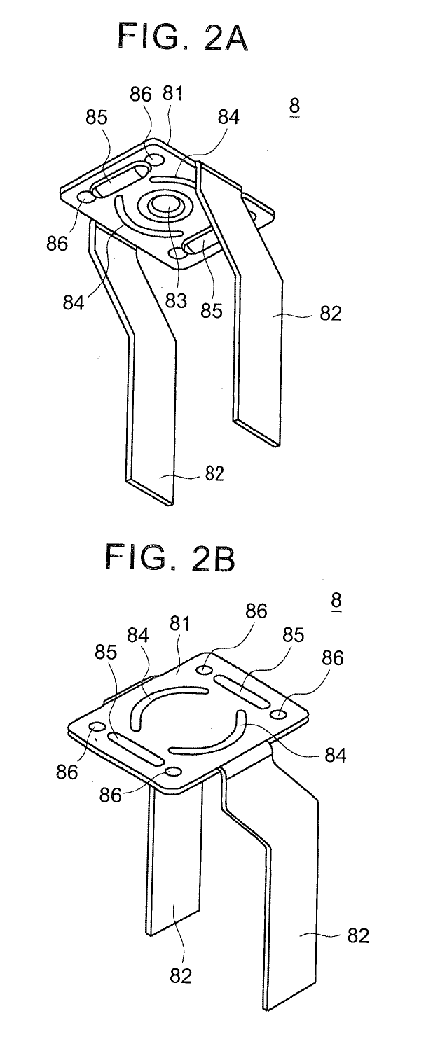

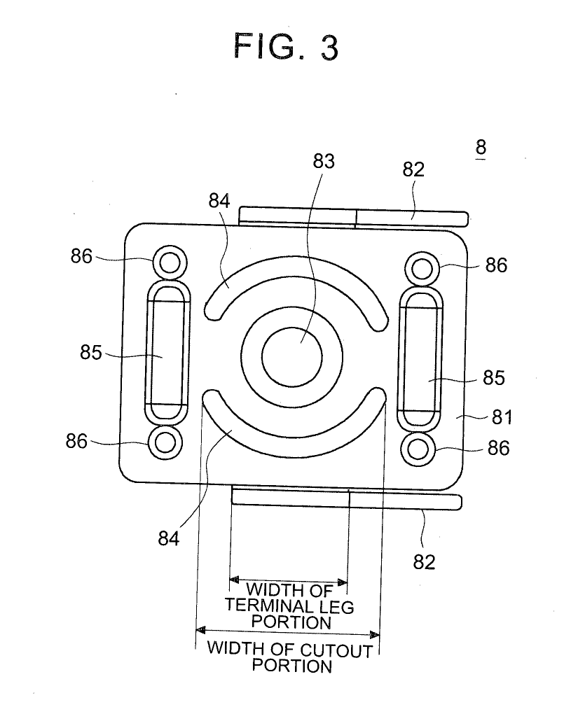

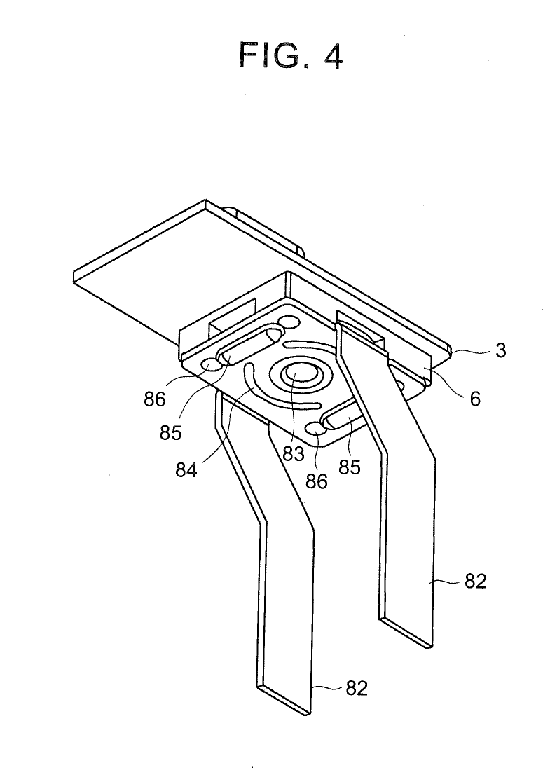

As shown in FIG. 1, the internal positive terminal 42 and the internal negative terminal 52 have bilaterally symmetrical structures. Therefore, the internal positive terminal 42 and the internal negative terminal 52 will hereinafter collectively be described in detail as a collector terminal 8. FIG. 2 is a perspective view showing a frame format of the collector terminal 8 according to the first example embodiment of the invention. FIG. 2A is a perspective view of the collector terminal 8 viewed from the inside of the battery case 2. FIG. 2B is a perspective view of the collector terminal 8 viewed from the sealing body 3 side. FIG. 3 is a plan view of the collector terminal 8 viewed from the inside of the battery case 2. FIG. 4 is a perspective view of the connection between the collector terminal 8 and the sealing body 3. FIG. 5 is a sectional view of the connecting portion of the collector terminal 8 and the sealing body 3.

The collector terminal 8 includes a base portion 81, terminal leg portions 82, a connecting portion 83 that connects the collector terminal to the current interrupting mechanism, cutout portions 84, protruding portions 85, and retaining portions 86 and the like. The base portion 81 is a generally rectangular-shaped plate, and faces the current interrupting mechanism 7. The base portion 81 is fixed to the sealing body 3 via the insulating member 6.

The connecting portion 83 that connects the collector terminal to the current interrupting mechanism (this connecting portion can be regarded as the connecting portion of the invention; hereinafter simply referred to as the “connecting portion 83”) is formed in substantially the center portion of a surface of the base portion 81 that is toward the inside of the battery case 2. More specifically, the connecting portion 83 is a circular recessed portion in a plan view. The position in which the connecting portion 83 is provided is not limited to the position described in this example embodiment.

Also, the current interrupting mechanism 7 is provided between the collector terminal 8, and the external positive terminal 41 and the external negative terminal 51. The current interrupting mechanism 7 is made of metal foil. An edge portion of the current interrupting mechanism 7 is electrically connected to the crimping members 413 and 513. The current interrupting mechanism 7 is electrically connected near the center portion thereof to the connecting portion 83 of the collector terminal 8. That is, the collector terminal 8 is electrically connected to the external positive terminal 41 or the external negative terminal 51 via the current interrupting mechanism 7. If the pressure inside the case formed by the battery case 2 and the sealing body 3 rises due to detective operation of the secondary battery 100 or the like, the current interrupting mechanism 7 will be pushed upward (to the sealing body 3 side) by the pressure, and the connection between the connecting portion 83 and the current interrupting mechanism 7 will break. As a result, the collector terminal 8 will be insulated from the external positive terminal 41 and the external negative terminal 51. In other words, the current interrupting mechanism 7 is a diaphragm made of metal foil.

The terminal leg portions 82 extend from the base portion 81, in a manner protruding toward the side opposite the side of the base portion 81 on which the insulating member 6′ is provided (i.e., toward the inside of the battery case 2). More specifically, each terminal leg portion 82 is a plate member that extends from substantially the center portion of two opposing sides of the base portion 81. In other words, a base of each terminal leg portion 82 is positioned in substantially the center portion on two opposing sides of the base portion 81. The terminal leg portions 82 are formed as a single member that is connected to the base portion 81. More specifically, the base of each terminal leg portion 82 is a portion that is bent with a curve from the base portion 81. The position in which each terminal leg portion 82 extends from the base portion 81 is not limited to the position described in this example embodiment. Also, the terminal leg portions 82 are electrically connected to the exposed end portion of the positive electrode sheet 11 or the negative electrode sheet 12 of the rolled body 1.

The cutout portions 84 are provided in the base portion 81, between the connecting portion 83 and the terminal leg portions 82. More specifically, two cutout portions 84 are formed in symmetrical positions with respect to the center point of the connecting portion 83, between the terminal leg portions 82 and the connecting portion 83. Each of the terminal leg portions 82 and the connecting portion 83 are provided in positions symmetrical with respect to one of the cutout portions 84 closer to the terminal leg portion 82 than the other of the cutout portions 84. In this example embodiment, each cutout portion 84 is an arc-shaped slit. The cutout portions 84 are formed in the base portion 81 with the arcs partially encircling the connecting portion 83. The width of each cutout portion 84 (i.e., the distance between the starting point and the ending point of the arc) is greater than the width of each terminal leg portion 82.

The protruding portions 85 are provided on the base portion 81, in positions farther toward the outside than the connecting portion 83 (i.e., farther toward an edge side than the connecting portion 83, on the base portion 81). In this example embodiment, two protruding portions 85 are provided on the base portion 81, in a manner symmetrical with respect to the connecting portion 83. Each protruding portion 85 is provided substantially parallel to a straight line that connects the connecting portion 83 to the terminal leg portions 82. That is, each protruding portion 85 is provided substantially parallel to a straight line that connects the center of the connecting portion 83 to substantially the center portion in the width direction of each terminal leg portion 82, at the base of each terminal leg portion 82. In other words, each protruding portion 85 is provided substantially parallel to the two opposing sides on which the terminal leg portions 82 are not provided. Each protruding portion 85 is a linear-shaped protruding portion formed raised (i.e., protruding) toward the inside of the battery case 2 on the base portion 81. A portion on a surface side that is the insulating member 6 side of the base portion 81, which corresponds to the protruding portion 85, is a recessed portion.

The retaining portion 86 is a through-hole portion provided in a corner portion (that can be regarded as an angular portion of the invention) of the base portion 81. One retaining portion 86 is provided in each of four corners of the base portion 81. The diameter of the through-hole portion becomes smaller from the battery case 2 side of the base portion 81 toward the insulating member 6 side. The portion of the insulating member 6 that corresponds to the retaining portion 86 protrudes so as to be able to fit into the retaining portion 86. The collector terminal 8 is attached to the insulating member 6 by fitting the portion of the insulating member 6 into the retaining portion 86. In this example embodiment, each protruding portion 85 is arranged between two retaining portions 86 that are arranged at corner portions that are end portions of sides on which the terminal leg portions 82 are not provided. Each protruding portion 85 may be provided substantially parallel to a straight line that connects the connecting portion 83 to the terminal leg portions 82, or arranged between the retaining portions 86.

With the collector terminal 8 and the secondary battery 100 according to the first example embodiment of the invention, even if a tensile load is applied to the terminal leg portions 82 in a direction toward the inside of the battery case 2 (i.e., the side opposite the current interrupting mechanism 7 side), the transmission of stress to the connecting portion 83 is able to be inhibited by the cutout portions 84. Also, an increase in electrical resistance, a decrease in power storing function, and defective operation of the secondary battery 100 are able to be inhibited.

The terminal leg portions 82 and the connecting portion 83 are provided in positions symmetrical with respect to the cutout portions 84. As a result, when a tensile load is applied to the terminal leg portions 82 in a direction toward the inside of the battery case 2, the transmission of stress to the connecting portion 83 is able to more reliably be inhibited by the cutout portions 84. The width of each cutout portion 84 (i.e., the distance between the starting point and the ending point of the arc) is greater than the width of each terminal leg portion 82. Therefore, when a tensile load is applied to the terminal leg portions 82 in a direction toward the inside of the battery case 2, the transmission of stress to the connecting portion 83 is able to be more effectively inhibited by the cutout portions 84.

The cutout portions 84 are arc-shaped slits, and are formed in the base portion 81 with the arcs partially encircling the connecting portion 83. As a result, transmission of the stress to the connecting portion 83 is able to be more reliably inhibited by the cutout portions 84. Furthermore, a current conduction path in the base portion 81 of the collector terminal 8 can be shortened, so there is less electrical resistance, compared with when the cutout portions 84 are linear-shaped slits.

The protruding portions 85 that are provided substantially parallel to a straight line that connects the connecting portion 83 to the terminal leg portions 82 are provided to the outside of the connecting portion 83 of the base portion 81. These protruding portions 85 enable the strength of the base portion 81 to be increased, and thus it possible to inhibit the base portion 81 from bending when a tensile load is applied to the terminal leg portions 82. As a result, stress that would be transmitted to the connecting portion 83 is able to be inhibited.

The base portion 81 is a plate member formed in a generally rectangular shape. The retaining portions 86 for retaining the collector terminal 8 are provided at the corner portions of the base portion 81. As a result, the tensile load applied to the terminal leg portions 82 is able to be evenly supported by the retaining portions 86, so deformation of the base portion 81 is able to be inhibited. Thus, stress that would be transmitted to the connecting portion 83 is able to be inhibited from being generated. The protruding portion 85 is arranged between the retaining portions 86 that are arranged at the corner portions that are end portions of the sides on which the terminal leg portions 82 are not provided. As a result, deformation of the base portion 81 when any external force is applied to the terminal leg portions 82 is able to be inhibited.

Hereinafter, examples and comparative examples of the invention will be described. FIG. 6 is a plan view of a collector terminal 8a according to Example 1 of the invention, viewed from the inside of the battery case 2. As shown in FIG. 6, the collector terminal 8a in the Example 1 is the same shape as the collector terminal 8 shown in FIGS. 2 to 5. Therefore, the portions of the collector terminal 8a will be denoted by the same reference characters as those used for the collector terminal 8, and descriptions of those portions will be omitted. The collector terminal 8a according to Example 1 of the invention is able to yield the same effects as the collector terminal 8 according to the first example embodiment of the invention.

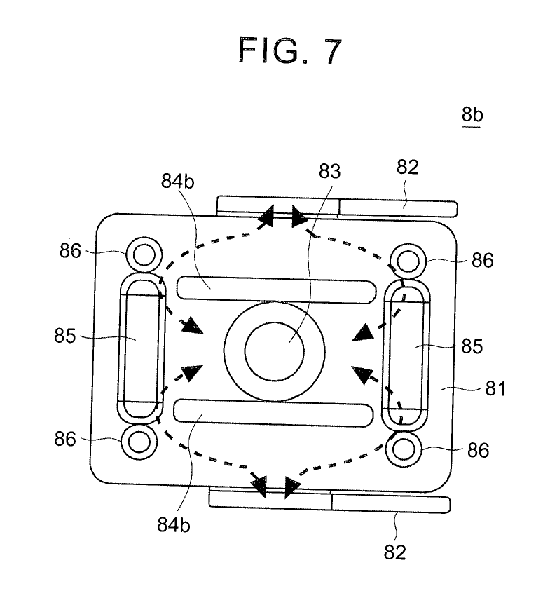

FIG. 7 is a plan view of a collector terminal 8b according to Example 2 of the invention, viewed from the inside of the battery case 2. As shown in FIG. 7, with the collector terminal 8b in Example 2, only the shape of the cutout portions 84b differs from that of the collector terminal 8a in Example 1. Therefore, structure of the collector terminal 8b that is the same as structure of the collector terminal 8a will be denoted by the same reference characters used for the collector terminal 8a, as descriptions of this structure will be omitted.

The cutout portions 84b differ from the cutout portions 84 of the collector terminal 8a in that the cutout portions 84b have linear shapes that are substantially parallel to the two opposing sides on which the terminal leg portions 82 are provided. The width of each cutout portion 84b (i.e., the distance between the starting point and the ending point of each cutout portion 84b) is greater than the width of each terminal leg portion 82.

The collector terminal 8b in Example 2 of the invention is able to yield effects substantially similar to those of the collector terminal 8a in Example 1. However, with the collector terminal 8b in Example 2, the current conduction path from the base of the terminal leg portions 82 to the connecting portion 83 is longer and narrower than it is with the collector terminal 8a in Example 1. Therefore, electric resistance of Example 1 is lower than thereof Example 2.

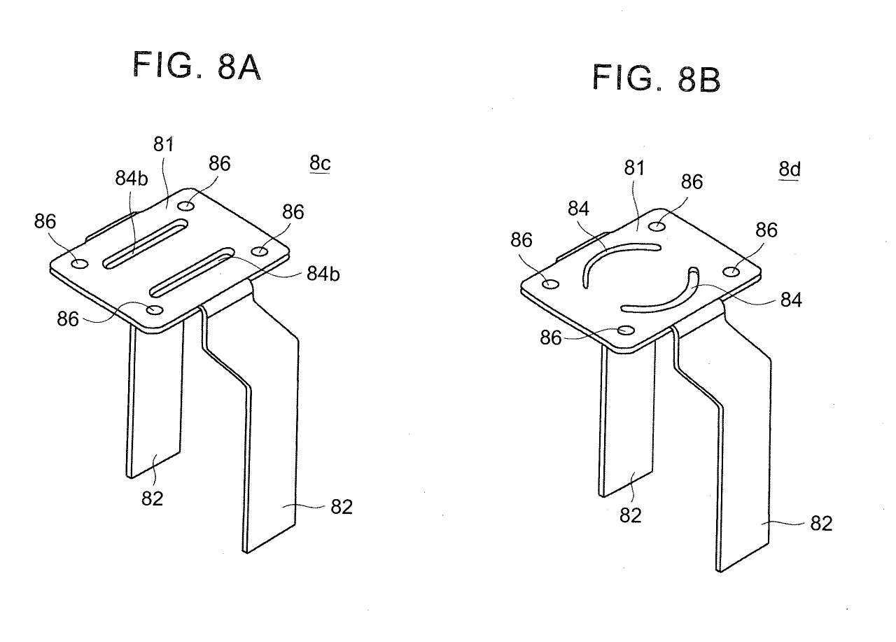

FIGS. 8A and 8B are plan views of a collector terminal 8c and a collector terminal 8d in Example 3 of the invention, viewed from the inside of the battery case 2. FIG. 8A is a view of the collector terminal 8c, and FIG. 8B is a view of the collector terminal 8d. As shown in FIGS. 8A and 8B, the collector terminal 8c and the collector terminal 8d in Example 3 differ from the collector terminal 8a in Example 1 and the collector terminal 8b in Example 2, in that they are not provided with the protruding portions 85. More specifically, the collector terminal 8c in Example 3 shown in FIG. 8A differs from the collector terminal 8b in Example 2 only in that it is not provided with the protruding portions 85. Also, the collector terminal 8d in Example 3 shown in FIG. 8B differs from the collector terminal 8a in Example 1 only in that it is not provided with the protruding portions 85. Therefore, like structure will be denoted by like reference characters and descriptions of this structure will be omitted.

With the collector terminal 8c and the collector terminal 8d in Example 3 of the invention, the rigidity of the base portion 81 is less than it is with the collector terminal 8a in Example 1 and the collector terminal 8b in Example 2, by an amount corresponding to the lack of the protruding portions 85. The rigidity of the base portion 81 decreases by providing the cutout portion 84 and 84b on the base portion 81. Therefore, the rigidity of the base portion 81 is improved with providing the protruding portions 85.

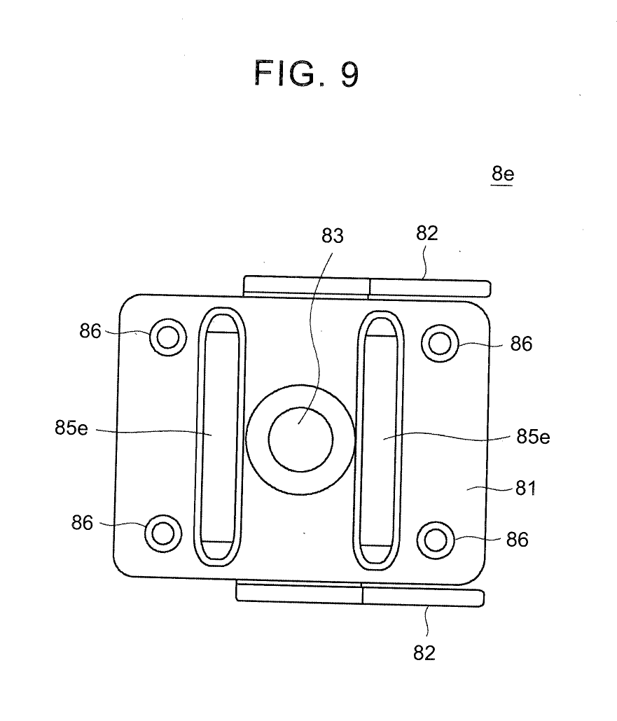

FIG. 9 is a plan view of a collector terminal 8e in Comparative example 1, viewed from the inside of the battery case 2. As shown in FIG. 9, the collector terminal 8e in Comparative example 1 differs from the collector terminals 8a, 8b, 8c, and 8d in Examples 1 to 3, in that the cutout portions 84 are not provided, and the positions in which protruding portions 85e are provided is different. Therefore, like structure will be denoted by like reference characters, and descriptions of this structure will be omitted.

The protruding portions 85e are provided on the connecting portion 83 side of the retaining portions 86 that are arranged at the corner portions that are the end portions of the sides on which the terminal leg portions 82 are not provided. In other words, the protruding portions 85e are not arranged between the retaining portions 86 that are arranged at the corner portions that are the end portions of the sides on which the terminal leg portions 82 are not provided.

The collector terminal 8e in Comparative example 1 has the protruding portions 85e, so the rigidity of the base portion 81 is improved, and as a result, the base portion 81 will not easily deform. However, if a tensile load is applied to the terminal leg portions 82, the base portion 81 will bend with the connecting portion 83 as the fulcrum. Therefore, the collector terminal 8e having the cutout portions 84 as in Examples 1 to 3 described above is able to better reduce the load applied to the current interrupting mechanism 7.

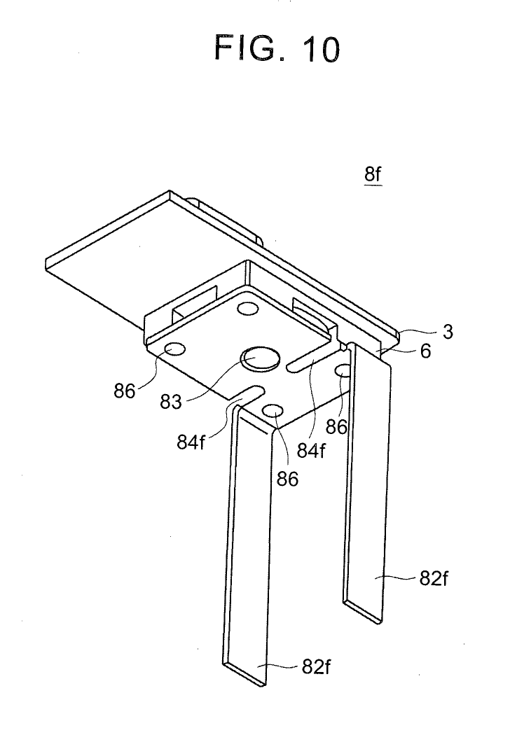

FIG. 10 is a perspective view of a connection between a collector terminal 8f and a sealing body 3 according to a second example embodiment of the invention. As shown in FIG. 10, the collector terminal 8f according to the second example embodiment differs from the collector terminal 8 according to the first example embodiment in that it is not provided with the protruding portions 85, and the structures of cutout portions 84f and terminal leg portions 82f are different. Therefore, like structure will be denoted by like reference characters, and descriptions of this structure will be omitted.

The terminal leg portions 82f extend from the base portion 81, in a manner protruding on the side opposite the insulating member 6 side of the base portion 81 (i.e., protruding toward the inside of the battery case 2). More specifically, each terminal leg portion 82f is a plate member that extends from one end of the end portion on two opposing sides of the base portion 81. In other words, the base of each terminal leg portion 82 is positioned on one end portion of two opposing sides of the base portion 81. Also, the terminal leg portions 82f are formed as a single member that is connected to the base portion 81. More specifically, the base of each terminal leg portion 82f is a portion that is bent with a curve from the base portion 81. Also, the terminal leg portions 82f are electrically connected to the exposed end portion of the positive electrode sheet 11 or the negative electrode sheet 12 of the rolled body 1.

The cutout portions 84f are provided between the connecting portion 83 and the terminal leg portions 82f. Also, in this example embodiment, each cutout portion 84f is a linear-shaped slit. More specifically, the cutout portions 84f are formed by the base portion 81 being cut out, substantially parallel to the sides on which the terminal leg portions 82f are not provided. The cutout portions 84f is extended from a position on the connecting portion 83 side of the terminal leg portions 82f, on the sides of the base portion 81 on which the terminal leg portions 82 are provided. The width of each cutout portion 84f (i.e., the distance between the starting point and the ending point of each cutout portion 84f) is greater than the width of each terminal leg portion 82f.

The collector terminal 8f according to the second example embodiment of the invention is able to yield effects substantially similar to those of the collector terminal 8 according to the first example embodiment. In particular, even if external force (such as vibration) that acts in the short direction of the terminal leg portions 82f is applied to the terminal leg portions 82f, transmission of stress to the connecting portion 83 is able to be inhibited by the cutout portions 84f. Also, an increase in electrical resistance, a decrease in power storing function, and defective operation of the secondary battery 100 are able to be inhibited.

A protruding portion provided substantially parallel to the sides on which the terminal leg portions 82f are provided may also be provided on the terminal leg portion 82f side of the connecting portion 83 of the base portion 81. In other words, a linear-shaped protruding portion may also be provided, substantially parallel to the sides on which the terminal leg portions 82f are provided, between the two cutout portions 84f. Providing this protruding portion increases the strength of the base portion 81, thus making is possible to inhibit the base portion 81 from bending when external force (such as vibration) that acts in the short direction of the terminal leg portions 82f is applied. Therefore, stress that would be transmitted to the connecting portion 83 is able to be inhibited from being generated.

The invention is not limited to the example embodiments described above. The invention is also not limited to the lithium-ion secondary battery described in the example embodiments.

1. A collector terminal of a secondary battery, comprising:
a base portion that is a plate member facing a current interrupting mechanism, and including a cutout portion and a connecting portion that connects to the current interrupting mechanism; and
a terminal leg portion protruding from the base portion, and extending to a side of the base portion opposite the current interrupting mechanism side,
the cutout portion being provided between the connecting portion and the terminal leg portion.

2. The collector terminal according to claim 1, wherein
the base portion includes a plurality of the cutout portions,
a plurality of the terminal leg portions protrude from the base portion, and
the cutout portions are provided between the terminal leg portions and the connecting portion, in positions symmetrical with respect to a center point of the connecting portion.

3. The collector terminal according to claim 1, wherein each of the cutout portions is an arc-shaped slit and is partially encircling the connecting portion.

4. The collector terminal according to claim 1 further comprising:
a protruding portion provided substantially parallel to a straight line that connects the connecting portion to the terminal leg portions, and being provided on the base portion, in a position to an outside of the connecting portion.

5. The collector terminal according to claim 1, wherein the base portion is a plate member with an N-angular shape, and a retaining portion that retains the collector terminal is provided on an angular portion of the base portion.

6. The collector terminal according to claim 1, wherein
the base portion is a rectangular-shaped plate member;
each of the terminal leg portions is a plate member extending from one end portion on two opposing sides of the base portion; and
each of the cutout portions is a linear-shaped slit, being provided parallel to a side on which the terminal leg portions are not provided, and extending from a position that is closer to the connecting portion than the terminal leg portions, on a side of the base portion on which the terminal leg portions are provided.

7. The collector terminal according to claim 6 further comprising: a protruding portion provided substantially parallel to a side on which the terminal leg portions are provided, the protruding portion being provided on the base portion, in a position that is closer to the terminal leg portion than the connecting portion of the base portion.

8. A secondary battery comprising:
an electrode body; and
a collector terminal that collects power from the electrode body, the collector terminal including a base portion and a terminal leg portion, the base portion that is a plate member facing a current interrupting mechanism, the base portion including a cutout portion and a connecting portion that connects to the current interrupting mechanism, the cutout portion provided between the connecting portion and the terminal leg portion, the terminal leg portion protruding from the base portion, the terminal leg portion extending to a side of the base portion opposite the current interrupting mechanism side.
